(19) United States
(12) Patent Application Publication
(10) Pub. No.: US 2019/0134746 A1
(43) Pub. Date: May 9, 2019

(54) Device for powder bed-based genrative production of metallic components

(71) Applicant: JENOPTIK Industrial Metrology Germany GmbH, Villingen-Schwenningen (DE)

(72) Inventor: Raimund Volk, Villingen-Schwenningen (DE)

(21) Appl. No.: 15/998,527

(22) Filed: Aug. 16, 2018

(30) Foreign Application Priority Data
Aug. 16, 2017 (DE) 10 2017 118 720.0
Aug. 21, 2017 (DE) 10 2017 119 080.5
Dec. 13, 2017 (DE) 20 2017 107 586.9
Dec. 20, 2017 (DE) 10 2017 130 669.2
Dec. 20, 2017 (DE) 10 2017 130 671.4

(51) Int. Cl. B23K 26/34; B33Y 30/00; B33Y 40/00; B33Y 50/02; B23K 26/354

(52) U.S. Cl. CPC B23K 26/34; B33Y 30/00; B23K 26/354; B33Y 50/02; B33Y 40/00

(57) ABSTRACT

Device for powder bed-based generative production of metallic components has a material reservoir accommodating a powdered metal material meltable by melting device, material in material reservoir forming a powder bed, and has machining device for machining the surface of the powder bed. Device for determining the three-dimensional topography of the surface of powder bed is provided configured so the three-dimensional topography of the surface is determined or determinable by obtaining surface depth information concerning the surface. Device for determining the three-dimensional topography of the surface of the powder bed is in signal transmission connection with the machining device so that the surface of the powder bed is machined or machinable as a function of output signals of the device for determining the three-dimensional topography of the surface of the powder bed that represent the three-dimensional topography of the surface of the powder bed.

### CROSS-REFERENCE TO RELATED APPLICATIONS

This application claims the priority of German Application No. 10 2017 118 720.0, filed Aug. 16, 2017, and this application claims the priority of German Application No. 10 2017 119 080.5, filed Aug. 21, 2017, and this application claims the priority of German Application No. 20 2017 107 586.9, filed Dec. 13, 2017, and this application claims the priority of German Application No. 10 2017 130 671.4, filed Dec. 20, 2017, and this application claims the priority of German Application No. 10 2017 130 669.2, filed Dec. 20, 2017, and each of which is incorporated herein by reference.

### FIELD OF THE INVENTION

The invention relates to a device of the type for powder bed-based generative production of metallic components.

### BACKGROUND OF THE INVENTION

Such devices, also referred to as 3D printers, are generally known, and are used for building three-dimensional workpieces. The workpieces are built in layers by computer control, using at least one powdered metallic material. Physical melting processes take place in the building of a three-dimensional structure. The devices are suitable in particular for forming complex geometric structures.

The known devices have a material reservoir for accommodating a melt of a meltable powdered metal material, the material in the material reservoir forming a powder bed and being selectively melted by means of a melting device, corresponding to the cross section of the component to be generated.

In addition, the known devices have a pull-off element for shaping the surface of the powder bed, wherein the pull-off element is designed in the manner of a doctor knife and defines a pull-off edge. The pull-off element is situated on a movable carrier, the carrier being designed in such a way that the pull-off edge is movable relative to the powder bed in order to pull off the surface of same.

During production of a component, prior to carrying out a melting operation the surface of the powder bed is smoothed by means of the pull-off element. The powdered metal material is subsequently selectively melted, corresponding to the cross section of the component to be produced, by means of the melting device, which is formed by a laser, for example.

After such a melting operation, in preparation for a subsequent melting operation a powder layer is once again applied by introducing additional powder into the material reservoir, and distributing and smoothing it along the surface of the powder bed by means of the pull-off element. In order for the surface of the powder bed to always be situated in the same plane during the production operation, and for the selective melting operation to thus likewise always take place in the same plane, the component together with the material reservoir is situated on a mounting that is movable perpendicular to the surface of the powder bed. After each melting operation, the mounting together with the component and the powder bed is lowered by an amount that corresponds to the thickness of the metal layer generated in the melting operation.

Devices for powder bed-based generative production of metallic components are known from DE 195 33 960 A1 and DE 10 2014 222 159 A1, for example.

A device for powder bed-based generative production of metallic components, is known from EP 2 942 130 A1.

### OBJECTS AND SUMMARY OF THE INVENTION

An object of the invention is to improve the functioning of a device of the type set forth above.

This object is achieved by the invention set forth herein.

In the building of workpieces made of metal, a metal in particular in powdered form that is accommodated in a material reservoir is used as formable material. The metal powder forms a powder bed that is irradiated with a laser or some other melting device, depending on the workpiece to be formed or the three-dimensional structure to be formed. The material is selectively melted by the laser radiation, and the desired workpiece or the desired three-dimensional structure is formed in layers upon solidification of the melted material. After a layer has melted and solidified, in preparation for the next layer it is necessary to once again create a powder bed having a suitable, in particular uniform, surface for the subsequent melting operation. For smoothing and equalizing the surface, in particular a tool in the manner of a doctor knife may be used which is guided over the powder surface.

The invention departs from the concept underlying EP 2 942 130 A1, of using a measuring device to measure the three-dimensional topography of the surface of the workpiece produced in layers, in order to detect defects on the workpiece.

Rather, the invention is based on the concept of improving the functional reliability and functional accuracy of the device by determining the topography of the surface of the powder bed, i.e., its three-dimensional structure, in an in-process method, in particular using an optical process, and based on the result, machining, in particular smoothing or structuring, the surface of the powder bed by use of the surface machining means. If it is established in the determination of the topography of the surface that a surface that is sufficiently uniform and suitable for a subsequent melting operation is present, the melting operation may be correspondingly carried out. If such a surface is not present, the surface may be machined, for example structured, in particular smoothed, as necessary.

Whereas devices known from the prior art detect defects in the layers of the workpiece after the fact, in the present invention the surface of the powder bed may be machined beforehand, i.e., prior to a melting operation, so that defects caused by an unsuitable, in particular nonuniform, surface of the powder bed may be avoided from the outset in generating the component.

The functional reliability and functional accuracy of such a device are thus significantly improved.

The invention thus allows in-process quality control, and optionally machining, of the powder bed surface during the ongoing manufacturing process. When such measurement methods are used, the invention allows recognition of even small, low-contrast surface deviations, as well as high measuring accuracy.

Another advantage of the invention is that a high lateral resolution and a high measuring speed may be achieved when such measurement methods are used.

Depending on the particular requirements, the surface of the powder bed may be machined, for example structured, in particular smoothed, by the machining means as desired in order to provide a surface that is suitable for the subsequent melting operation.

The means for determining the topography of the surface of the powder bed are advantageously fixedly installed in the device, and are integrated into a control unit of the device for control purposes, as provided in one advantageous refinement of the invention. According to the invention, “integrated into a control unit of the device for control purposes” is understood to mean that operations in the device take place as a function of the topography determination provided according to the invention. This may take place, for example, in such a way that a melting operation during layered building of a metallic component is not enabled or triggered until the topography determination provided according to the invention has shown that the surface of the powder bed is smooth enough to properly carry out the melting operation, or has been smoothed by the machining means after the measurement. The integration for control purposes may also be designed, for example, in such a way that the melting operation is stopped and/or an error signal is output when the topography determination shows that the surface of the powder bed is not smooth or flat enough to properly carry out the melting operation.

The topography of the surface may be determined according to any suitable functional principle or measuring principle, wherein, for example and in particular, measurement methods known from production measurement technology may be used, for example pneumatic distance measurement according to DIN 2271, or transit time measurement of sound or light. Optical measurement methods that operate without contact, that may be quickly carried out, and that have high measuring accuracy are particularly preferred according to the invention. In this regard, one advantageous refinement of the invention provides that the means for determining the topography of the surface of the powder bed have optical means that are designed and configured in such a way that the topography of the surface of the powder bed is determined or determinable by obtaining surface depth information. Any suitable optical measurement methods may be used, for example distance measurement with a confocal chromatic distance sensor, sample projection, and, for example, also white light interferometry and deflectrometry methods.

To allow the melting operation to be carried out quickly, easily, and precisely, one advantageous refinement of the invention provides that the melting device has at least one laser and/or at least one electron beam melting device whose laser beam or electron beam, respectively, under control by a control unit, is movable along the surface of the powder bed and variable in its intensity for selectively melting the powdered material.

Another advantageous refinement of the invention provides that the surface machining means have at least one smoothing device for smoothing the surface of the powder bed. The design of such a smoothing device is generally known per se to those skilled in the art and is therefore not explained in greater detail here.

According to another advantageous refinement of the invention, the means for determining the topography of the surface of the powder bed are designed and configured for measuring the surface of the powder bed, and have at least one measuring device that is capable of 3D measurement. In this embodiment, the topography of the surface is determined by measuring same.

Any suitable measuring devices or measurement methods may be used in the above-mentioned embodiment. In this regard, one advantageous refinement of the invention provides that the measuring device is designed as an optical measuring device or includes an optical measuring device. Such measuring devices allow contactless measurement of the surface of the powder bed with great accuracy and high speed, and are thus particularly suitable for determining the topography of the surface.

One extremely advantageous refinement of the invention provides that the optical measuring device has at least one optical sensor that is in data transmission connection with an evaluation device that is designed and configured in such a way that the topography of the surface of the powder bed is reconstructed or reconstructable from the output signals of the sensor, using a 3D reconstruction method. In this embodiment, a sensor is used whose output signals allow 3D reconstruction of the topography of the surface of the powder bed.

According to the invention, a sensor that is stationary relative to the material reservoir, and thus relative to the powder bed, may be used which detects the powder bed linearly or along multiple lines, for example, in particular in areas that have proven to be particularly problematic with regard to smoothing. One extremely advantageous refinement of the invention provides that the optical sensor is designed for scanning the surface of the powder bed. Complete, seamless determination of the topography of the surface of the powder bed is thus made possible, and the functional reliability of the device according to the invention is further increased.

In this regard, one advantageous refinement of the invention provides that the optical sensor is situated on a carrier that is movable relative to the surface of the powder bed. This results in a particularly simple design.

Any suitable sensors may be used as sensors in the embodiment with the optical sensor. In this regard, one advantageous refinement of the invention provides that the optical sensor is designed as a line sensor and has a linear arrangement of sensor elements. Such line sensors are available as relatively simple, economical standard components, and allow high measuring accuracy. In particular, under certain circumstances line sensors may be used with an integrated illumination device, as generally known from flatbed scanners.

One refinement of the embodiment with the carrier provides that the carrier is linearly movable relative to the material reservoir. This results in a particularly simple design of the movable parts.

According to another advantageous refinement of the invention, the carrier is rotatable relative to the material reservoir, in particular in the manner of a windshield wiper.

Another advantageous refinement of the invention provides an illumination device for illuminating the surface of the powder bed, at least in an area detected by the sensor.

Another refinement of the invention provides that the illumination device is designed and configured for illuminating the surface of the powder bed at different illumination angles, and that the evaluation device is designed and configured for evaluating output signals of the optical sensor, obtained during illumination at different illumination angles, according to the “shape from shading” method. The shape from shading method is generally known, and allows the topography of the surface of the powder bed to be determined in a relatively simple manner.

One extremely advantageous refinement of the invention provides that the optical sensor is designed and configured for observing a measuring point on the surface of the powder bed from different observation angles. Determining the topography is thus made possible in a particularly simple manner, using suitable 3D reconstruction methods. The observation of a measuring point from different observation angles may take place by moving the sensor relative to a, or each, measuring point and observing or imaging the measuring point in each position. However, it is also possible to observe each measuring point from different observation angles, using single detectors of an optical sensor. A line sensor in particular is suitable for this purpose, wherein each measuring point is observed by two single detectors of the line sensor from different angles, and the output signals of the detectors are appropriately evaluated.

One extremely advantageous refinement of the above-mentioned embodiment provides that the evaluation device is designed and configured for evaluating output signals of the optical sensor according to the stereo triangulation method. The stereo triangulation method allows rapid, highly precise determination of the topography of the surface of the powder bed.

However, other optical measurement methods are also usable according to the invention. Thus, one alternative embodiment provides that the optical sensor is designed as a distance sensor that measures single points, and the topography of the surface of the powder bed is determined by ascertaining the distance between the sensor and the surface at the particular measuring point detected by the sensor.

Another advantageous refinement of the invention provides that the sensor is integrated with the illumination device to form a sensor/illumination unit. Such sensor/illumination units are available as relatively simple, economical standard components. In particular, sensor/sensor illumination units as known from flatbed scanners may be used. In contrast to the use of flatbed scanners, in which only a single image of an object to be scanned is generated, when such a sensor/illumination unit is used in a device according to the invention it is possible to obtain surface depth formations in addition to an image, for example, as stated above, by observing each measuring point on the surface of the powder bed from different observation angles by means of at least two single detectors of the line sensor, and appropriately evaluating the output signals of the single detectors.

Another advantageous refinement of the invention provides that the sensor/illumination unit is situated on the carrier.

If the three-dimensional topography of the surface of the powder bed is measured after application of a new powder layer and smoothing of the surface of the powder bed, the evaluation device may determine, for example, whether the surface of the powder bed is flat or smooth as required. On the other hand, if the topography of the surface is determined after a melting operation and before application of a new powder layer, the output signals of the in particular optical sensor in the areas in which the surface is formed by melted and solidified metal, and which are transmitted to the evaluation device, contain information concerning the applicable cross-sectional area of the component to be produced. Accordingly, another advantageous refinement of the invention provides that the evaluation device is designed and configured for checking and/or measuring a cross-sectional area, formed by melting on of the powder, of the component to be produced, based on the output signals of the optical sensor.

One extremely advantageous refinement of the invention that has independent inventive importance taken alone in combination with the features of the outset of the body of claim 1, even without the features of the remainder of the body of claim 1, provides that the surface machining means have at least one pull-off element for shaping the surface of the powder bed, wherein the pull-off element is designed in the manner of a doctor knife and defines a pull-off edge, wherein the, or each, pull-off element is situated on a movable carrier, and wherein the carrier is designed in such a way that the pull-off edge is movable in a pull-off plane in order to pull off the surface of the powder bed relative to the powder bed, wherein the, or each, pull-off element is situated on the carrier so as to be adjustable, relative to the carrier, along an adjustment axis perpendicular to the pull-off plane in order to set a pull-off position of the pull-off edge, wherein during the pull-off operation the pull-off position, at least in phases, is fixed or is changeable relative to the carrier, corresponding to a high-frequency oscillation about a zero position, and wherein a drive device is associated with the adjustment axis.

The basic concept of this embodiment lies in designing the device in such a way that the surface of the powder bed may be shaped corresponding to a desired topography, in order to allow process parameters of the production method to be influenced in a targeted manner. According to the invention, this basic concept is implemented by the, or each, pull-off element being movable relative to the carrier perpendicular to the pull-off plane.

By adjusting the position of the pull-off edge along the adjustment axis, the surface of the powder bed may be shaped or structured for each layer application of powder, corresponding to a desired topography.

Since the adjustment along the adjustment axis takes place by means of a drive device, an automatic adjustment of the pull-off element or the pull-off elements is made possible, so that the operation of a device according to the invention may be further automated.

The freedom of design of the process parameters for the melting operation is increased due to the shaping of the surface of the powder bed that is made possible according to the invention.

Another advantage of the embodiment with the pull-off element is that initial installation of the device, as well as reinstallation, for example after damage, are simplified.

As a result, the productivity of the device is once again significantly increased.

The pull-off position of the pull-off edge relative to the carrier may be fixed, at least in phases, during the pull-off operation. This means that the pull-off position may remain unchanged during the entire pull-off operation, and a powder layer of essentially constant thickness may thus be applied. However, it is also possible to change the pull-off position relative to the carrier during the pull-off operation in phases, so that the thickness of the applied powder layer is modulated corresponding to the change in the pull-off position.

However, it is also possible to change the pull-off element in the pull-off position corresponding to a high-frequency oscillation about a zero position, and thus to set the pull-off element in vibration. With an appropriate design, the zero position defines the actual layer thickness of the powder layer, while the pourability of the powder is improved due to the high-frequency oscillation.

The operating principle of such a device according to the invention is improved over the prior art in that the, or each, pull-off element is adjustable relative to the carrier along an adjustment axis perpendicular to the pull-off plane, as provided by the invention.

One extremely advantageous refinement of the embodiment with the pull-off element provides that the pull-off edge is formed by at least two pull-off elements next to and adjoining one another in the longitudinal direction of the pull-off edge, wherein the pull-off edge is preferably formed by a plurality of pull-off elements next to and adjoining one another in the longitudinal direction of the pull-off edge, as provided by one refinement.

In this way, it is possible not only to change the thickness of the applied powder layer or modulate it in the pull-off direction, but also to adjust the thickness of the powder layer in the longitudinal direction of the pull-off edge, i.e., transverse to the pull-off direction, depending on the desired pattern. It is thus possible to adapt the topography of the surface of the powder bed within wide limits, depending on the particular requirements. Thus, the more pull-off elements that are provided, the finer the shaping or structuring of the surface of the powder layer that is made possible. The pull-off elements next to and adjoining one another together form the pull-off edge, which is structured corresponding to the particular pull-off position (vertical position) of the individual pull-off elements, so that a surface of the powder bed that corresponds to the structure of the pull-off edge is formed during the pull-off operation. It is also possible to adjust the pull-off elements relative to one another during the pull-off operation, so that an individually configured powder application is made possible at each location on the powder bed. As a result, the topography of the surface of the powder bed may be finely structured, depending on the particular requirements, the fine structuring in principle being better the greater the number of pull-off elements.

With regard to a mutually independent adjustment of the pull-off elements, one advantageous refinement provides that a separate, independently controllable drive device is associated with at least two pull-off elements, preferably each of the pull-off elements.

The drive device in question may be any given motorized drive device. For example, at least one drive device may be designed as a piezo actuator or piezo motor.

With regard to a simple and economical design of the device, one refinement of the embodiment with the pull-off element provides that at least one drive device is designed as a piezo actuator. Such piezo actuators are available as relatively simple, economical standard components. In particular, actuator modules in the form of actuator strips, having more than 80 closely spaced actuators, are also known and commercially available.

A control unit as provided in another refinement of the invention is advantageously provided for controlling the drive device or the drive devices. The topography of the surface may be influenced, according to the particular requirements, during the pull-off operation by appropriate programming of the control unit, and the surface of the powder bed may thus be correspondingly shaped.

One extremely advantageous refinement of the embodiment with the pull-off element provides a measuring device for three-dimensional measurement of the topography of the surface of the powder bed. In such an embodiment, the powder surface may initially be measured by means of the measuring device, and then shaped or structured during the pull-off operation, depending on the particular requirements. The surface of the powder bed may thus be shaped, according to the particular requirements, at any location with a high level of reliability. As the result of the topography of the powder surface not only being influenceable in a targeted manner, but also measurable, the process reliability of the device is significantly increased. Prior to the application of a new powder layer, the particular location on the powder bed where an individual powder application is necessary may be determined by means of the measuring device in order to achieve a desired topography. However, it is also possible, after the application of a powder layer, to check by means of the measuring device as to whether a desired topography of the powder surface has been achieved.

One advantageous refinement of the above-mentioned embodiment provides that the measuring device is in signal transmission connection with the control unit for controlling the drive device or drive devices, in such a way that the drive device or the drive devices is/are controlled or controllable as a function of the measuring result of the measuring device. In this way, the powder application takes place as a function of the measuring result provided by the measuring device.

In this regard, one advantageous refinement of the invention provides that the control unit is programmed for automatically controlling the drive device or the drive devices as a function of the measuring result of the measuring device, in such a way that a desired topography of the surface of the powder bed is automatically formed.

The measuring principle of the measuring device is selectable within wide limits, depending on the particular requirements. In this regard, one advantageous refinement of the invention provides that the measuring device is designed as an optical measuring device. Such optical measuring devices allow measurement of the topography of the surface of the powder bed with high speed and accuracy.

Another advantageous refinement of the embodiment with the pull-off element provides that the pull-off element or the pull-off elements is/are situated on a pull-off element module.

One refinement of the above-mentioned embodiment provides that the pull-off element module or a portion of the pull-off element module is detachably connected or connectable to the carrier. This simplifies replacement of the pull-off element or pull-off elements, for example within the scope of a periodic replacement or a replacement after damage.

One advantageous refinement of the above-mentioned embodiments provides that the pull-off element module has a passive pull-off edge module on which a plurality of adjacently situated pull-off edge elements, independently movable in the direction along the adjustment axis, are situated, and an active actuator module on which a plurality of independently controllable actuators are situated, each of which is associated with one of the pull-off edge elements in order to adjust same along the adjustment axis. Such a modular design allows, for example and in particular, separate replacement of the pull-off edge modules while the actuator module remains on the carrier. It is thus particularly easy to replace the pull-off edge module, for example after it has become worn or damaged.

In the embodiments with the pull-off edge module, this element may be designed in any suitable manner, depending on the particular requirements. To design the pull-off edge module to be manufacturable in a particularly easy and cost-effective manner, one advantageous refinement provides that the pull-off edge module has a strip, made of sheet metal or some other elastically deformable material with an angular shape, that has a first leg that is divided into tongue-like pull-off edge segments by indentations spaced apart from one another along the longitudinal direction of the pull-off edge, and that has another leg that is connected or connectable to the carrier or to a component joined to the carrier, wherein each of the pull-off edge segments is movable along the adjustment axis by an associated actuator.

To improve the pourability of the powder during the pull-off operation, another advantageous refinement of the embodiment with the pull-off element provides a vibration device for acting on the pull-off element or the pull-off elements with high-frequency oscillations.

Another advantageous refinement of the embodiment with the pull-off element provides that the carrier is designed and configured for a translational movement along a linear pull-off axis.

A movement of the pull-off element along the adjustment axis may be achieved by translationally or linearly moving the pull-off element along the adjustment axis, for example by means of a linear drive. In this regard, one advantageous refinement of the invention provides that at least one pull-off element is translationally movable for adjustment along the adjustment axis.

However, a movement of the pull-off element along the adjustment axis may also be achieved by a rotational movement of the pull-off element about an (actual or virtual) rotational axis extending transversely with respect to the adjustment axis. In this regard, another advantageous refinement of the invention provides that at least one pull-off element is rotatable about a rotational axis for adjustment along the adjustment axis. For example, an actuator may be associated in each case with the ends of an elongated pull-off element situated in the longitudinal direction, so that the pull-off element is translationally movable by equal actuations of both actuators, and is rotatable or tiltable by different actuations of the actuators.

Another extremely advantageous refinement of the invention that has independent inventive importance taken alone in combination with the features of the outset of the body of claim 1, even without the features of the remainder of the body of claim 1, provides that the surface machining means for removing material from the powder bed and/or from the component.

This embodiment is based on the finding that in the powder bed-based generative production of metallic components, in which for generation of the component the powder accommodated in the powder bed is selectively melted corresponding to the cross section of the component to be generated, metallic melt particles are formed which undesirably enter the powder bed or accumulate on the component. The metallic melt particles on the one hand interfere with the further process sequence due to the fact that they interrupt the surface of the powder bed. On the other hand, in subsequent melting operations, accumulated metallic melt particles on the component may result in melts having undefined geometries, and thus, defects in the component. Both of these factors impair the quality of the generated components and interfere with the process sequence.

On this basis, the concept underlying this embodiment is to improve the quality of the components and to provide a reliable process sequence by removing such metallic melt particles or other foreign bodies, also referred to below as anomalies, from the powder bed and from the component, if necessary.

This embodiment in particular provides the option to remove metallic melt particles (metal spatters) from the powder bed or from the component, thus reliably avoiding damage due to such particles during subsequent melting operations.

In this way, the reliability of the 3D printing is improved by avoiding defects caused by spattering.

Due to the increased reliability of the process sequence, the invention extends the option to carry out powder bed-based generative production of metallic components (3D printing of metallic components) unattended, and thus to further automate the production.

This results in higher productivity of the 3D printer, and considerable time and cost savings.

According to the invention, there is an option to detect and localize metal spatters in the powder bed or on the component, for example by imaging or measuring the powder bed and the component. Localized melt particles may then be selectively removed from the powder bed by suitable means.

However, it is also possible according to the invention to ablate and thus remove the entire powder layer that forms the surface of the powder bed, thus at the same time also removing melt particles and possibly other undesirable foreign bodies from the powder bed.

According to the invention, removing material from the powder bed and/or from the components is understood to mean that material is removed from that region of the powder bed that is relevant for the production of the component, and that within the scope of the production operation is acted on by laser radiation, for example. Accordingly, one refinement of the invention provides that the means for removing material from the powder bed and/or from the component are designed and configured for displacing material along the surface of the powder bed. In one such embodiment, the region of the surface of the powder bed that is relevant for the production operation is kept free of metal particles and other undesirable foreign bodies, which are displaced into another region on the surface of the powder bed, for example in the edge region of the powder bed, that is not relevant for the production of the component. The displaced material then does not interfere with the sequence of the production process, and may be removed from the powder bed at a later time.

Another advantageous refinement of the embodiment with the means for removing material from the powder bed and/or from the component provides that the means for removing material from the powder bed and/or from the component are designed and configured for removing melt particles or other foreign bodies. In this embodiment, melt particles and other foreign bodies are removed from the powder bed so that they no longer interfere with the subsequent melting operations. The melt particles may thus essentially be selectively removed, i.e., while preserving the surface of the powder bed. However, it is also possible according to the invention to remove the melt particles together with a surface layer of the powder.

Accordingly, another advantageous refinement of the embodiment with the means for removing material from the powder bed and/or from the component provides that the means for removing material from the powder bed and/or from the component are designed and configured for removing powder from the powder bed. According to the invention, powder together with melt particles or other anomalies may thus be removed from the powder bed. However, it is also possible to remove powder from regions of the powder bed that are not acted on by melt particles or other foreign bodies from the powder bed, if this is necessary or desirable within the scope of the production operation.

One extremely advantageous refinement of the embodiment with the means for removing material from the powder bed and/or from the component provides means for detecting and/or localizing melt particles in the powder bed and/or on the component. In this embodiment, melt particles or other foreign bodies in the powder bed are localized so that they may be removed in a subsequent method step. This embodiment also allows a determination of whether melt particles or foreign bodies are even present at all in the powder bed or on the component, and whether steps must accordingly be taken to remove the metal spatters or the like.

Another extremely advantageous refinement of the embodiment with the means for removing material from the powder bed and/or from the component provides a measuring device for measuring the surface of the powder bed and/or of the component. In particular by three-dimensional measurement of the surface of the powder bed and of the component, precise conclusions may be drawn concerning the state of the powder bed and of the component at a given moment, so that an accurate assessment may be made as to whether the production operation is taking place exactly in the desired manner, or whether corrective interventions in the production operation are necessary.

Any suitable measuring devices may be used in the above-mentioned embodiment. One particularly advantageous refinement of the embodiment with the measuring device provides that the measuring device is an optical measuring device. Such optical measuring devices allow in particular three-dimensional measurement of the surface of the powder bed and of the component with high accuracy and speed. Any suitable optical measuring devices may be used, for example measuring devices that measure the three-dimensional topography of the surface of the powder bed. It is also possible to use an imaging optical measuring device and to determine, based on recorded images using image recognition and pattern recognition methods, whether anomalies are present in the powder bed or on the component. It is also possible to design the measuring device in the manner of a thermal camera, and in particular to localize melt particles that are present on the surface of the powder bed.

Another extremely advantageous refinement of the embodiment with the means for removing material from the powder bed and/or from the component provides that the measuring device is in data transmission connection with an evaluation device that is designed and programmed for detecting and/or localizing melt particles or other foreign bodies in the powder bed and/or on the component, in such a way that the evaluation device, based on the measured data, detects melt particles or other foreign bodies and thus constitutes the means for detecting and/or localizing melt particles in the powder bed and/or on the component. In this embodiment, the detection and localization of anomalies (melt particles or the like) in the powder bed or on the component take place automatically.

To further automate the process sequence of the production method, one advantageous refinement provides that the evaluation device is in data transmission connection with a control unit, and transmits evaluation data to the control unit that represent the position of metal spatters or other foreign bodies detected in the powder bed and/or on the component, wherein the control unit is designed and programmed for controlling the means for removing material from the powder bed and/or from the component, in such a way that the means for removing material from the powder bed and/or from the component remove detected melt particles or other foreign bodies from the powder bed or from the component.

One advantageous refinement of the above-mentioned embodiment provides that the means for removing material from the powder bed and/or from the component have at least one apparatus, situated on a carrier, for removing material from the powder bed and/or from the component, the carrier being movable relative to the surface of the powder bed. The number, design, and functional principle of the apparatus or the apparatuses are selectable within wide limits, depending on the particular requirements.

To design such an apparatus so that it has a particularly simple construction and is functionally reliable, one extremely advantageous refinement of the invention provides that the means for removing material from the powder bed and/or from the component have at least one apparatus that is designed as a suction unit having at least one suction nozzle. In this embodiment, material from the powder bed is suctioned out in the manner of a vacuum cleaner. With an appropriate design of the suction unit and of the negative pressure used, material may be removed from the powder bed quickly and with high precision.

If the material to be removed is magnetizable, the means for removing material from the powder bed and/or from the component may have a magnet device, for example, so that the material is “suctioned out” magnetically.

Another advantageous refinement of the embodiment with the means for removing material from the powder bed and/or from the component provides that the means for removing material from the powder bed and/or from the component have at least one apparatus with a brush-like design. An apparatus designed as a brush may be used in particular for brushing metal spatters or other foreign bodies from the component. Due to the high temperature of the component after the melting operation, a brush made of heat-resistant material is advantageously used for this purpose. However, with such an apparatus it is also possible to displace powder along the surface of the powder bed by “brushing away.” Such a brush may also be used for “brushing out” material from the powder bed, for example by conveying the material by brushing it over an edge of the material reservoir.

In the embodiments with the suction unit, one advantageous refinement provides that at least one suction nozzle is designed for pinpoint suction. Such a suction nozzle allows material to be selectively suctioned, wherein the surface of the powder bed situated outside the suction area remains essentially untouched. Localized anomalies may thus be suctioned out of the powder bed with local delimitation. In principle, a single suction nozzle is sufficient. However, the number and design of the suction nozzles are selectable within wide limits, depending on the particular requirements.

If the aim is not to suction out individual anomalies with local delimitation, but, rather, to suction out a complete layer on the surface of the powder bed, it is advantageous when at least one suction nozzle is designed for linear or flat suction, as provided in another advantageous refinement of the invention.

To suction out a complete layer on the surface of the powder bed, it is advantageous when at least one suction unit is designed for suctioning out powder from the powder bed, as provided in another advantageous refinement. When a layer is suctioned from the surface of the powder bed, the thickness of the suctioned layer may be selected within wide limits, depending on the particular requirements. In this regard, suctioning strictly at the surface, with a layer thickness within an order of magnitude of a particle size or multiple particle sizes of the powder, is possible. However, deeper suctioning at an appropriate greater depth is also possible.

One advantageous refinement of the embodiments with the suction unit provides that a filter unit for filtering suctioned material is situated downstream from at least one suction unit. In this way, for example melt particles may be separated from powder in the suctioned material, and the powder may be recycled. If powder of a different material is present in the powder bed, different types of powder may be separated from one another after the suctioning in order to recycle the powder.

The invention is explained in greater detail below based on exemplary embodiments, with reference to the appended, highly schematic drawings. All features that are described, illustrated in the drawings, and claimed in the patent claims, alone or in any suitable combination, constitute the subject matter of the invention, regardless of their recapitulation in the patent claims or their back-reference, and regardless of their description or illustration in the drawings.

The subject matter and disclosed content of the patent application also include subcombinations of the claims in which at least one feature of the particular claim is omitted or replaced by another feature.

It is apparent to those skilled in the art that the individual features of the exemplary embodiments refine the particular exemplary embodiment taken alone, i.e., independently of the other features of the exemplary embodiment. The disclosed content of the patent application also includes combinations of the features of the exemplary embodiments with one another, so that each feature of one exemplary embodiment, independently of the other features of this exemplary embodiment, is also transferable to the other exemplary embodiments.

Relative terms such as left, right, up, and down are for convenience only and are not intended to be limiting.

### BRIEF DESCRIPTION OF THE DRAWINGS

The figures show the following:

FIG. 1 shows a highly schematic perspective view of one exemplary embodiment of a device according to the invention for powder bed-based generative production of metallic components,

FIG. 2 shows another schematic perspective view of the device according to FIG. 1,

FIG. 3 shows a perspective schematic diagram of a pull-off element in a first exemplary embodiment of a device according to the invention,

FIG. 4 shows a second exemplary embodiment in the same illustration as FIG. 3,

FIG. 5 shows another perspective schematic diagram for explaining the operating principle of the exemplary embodiment according to FIG. 4,

FIG. 6 shows a highly schematic diagram of one embodiment of a pull-off edge module,

FIG. 7 shows a block diagram of a device according to the invention,

FIG. 8 shows a schematic diagram of one exemplary embodiment of a device according to the invention, including means for removing material from the powder bed and/or from the component,

FIG. 9 shows a top view of the device according to FIG. 8, and

FIG. 10 shows a schematic diagram of layering of different types of powder in one exemplary embodiment of a production method according to the invention.

### DETAILED DESCRIPTION OF THE INVENTION

Identical or corresponding components are provided with the same reference numerals in the figures.

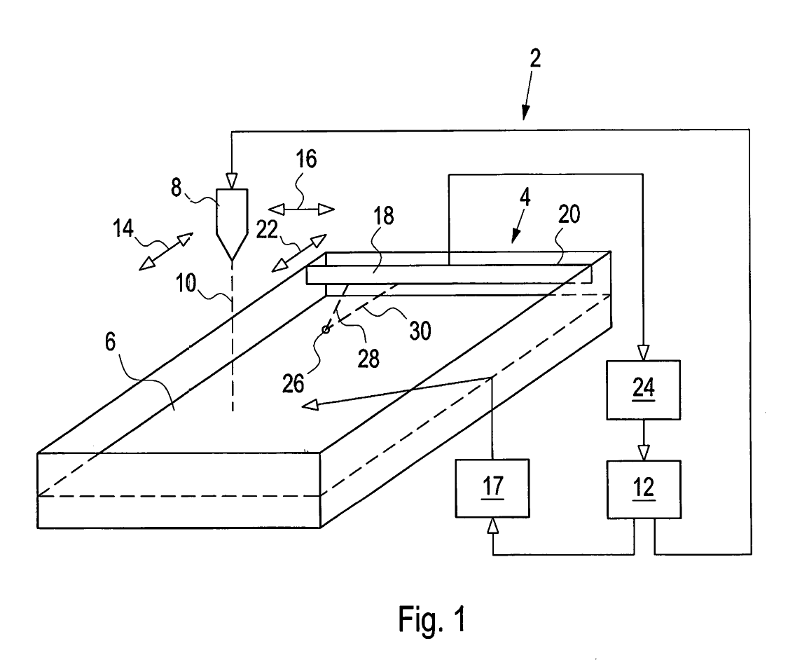

The invention is explained in greater detail below based on exemplary embodiments, with reference to FIGS. 1 through 6.

FIG. 1 shows a highly schematic illustration of one exemplary embodiment of a device 2 according to the invention for powder bed-based generative production of metallic components, with a material reservoir 4, illustrated only schematically, for accommodating a metallic powder material which is meltable by means of a melting device, and which forms a powder bed 6 in the material reservoir 4.

In the illustrated exemplary embodiment, the melting device includes a laser 8, whose laser beam 10, under control by a control unit 12, is movable along the surface of the powder bed 6 and variable in its intensity in order to selectively melt the powdered metal material. In the drawing, arrows 14, 16 indicate that the position of the laser beam 10 relative to the powder bed 6 is changeable in two dimensions, so that any desired positions may be accessed within the powder bed 6.

For smoothing the surface of the powder bed 6, surface machining means for machining the surface of the powder bed 6 are provided, which in the simplest case have an apparatus for shaping, in particular smoothing, the surface of the powder bed 6, but which for reasons of simplification are merely schematically indicated and provided with reference numeral 17 in FIG. 1.

In other respects, devices and methods for powder bed-based generative production of metallic components are generally known to those skilled in the art, and therefore are not discussed here in greater detail, provided that their details are not specific to the invention.

According to the invention, in the illustrated exemplary embodiment optical means for determining the topography of the surface of the powder bed 6 are provided.

In the illustrated exemplary embodiment, these optical means have an optical measuring device 18, capable of 3D measurement, with an optical sensor which in the illustrated exemplary embodiment is designed as a line sensor and is situated on a sensor support 20 that is movable relative to the powder bed 6 along a linear axis, as indicated in the drawing by an arrow 22. The line sensor extends over the entire width of the powder bed 6, so that every location on the surface of the powder bed 6 may be scanned by linearly moving the sensor in the direction of the arrow 22.

The line sensor has a linear arrangement of sensor elements and an integrated illumination device for illuminating the surface of the powder bed 6 in the area detected by the line sensor area. The line sensor together with the illumination device is integrated to form a sensor/illumination unit.

The output signals of the line sensor are supplied to an evaluation device 24.

By means of the linearly arranged sensor elements of the line sensor, each point on the surface of the powder bed 6 may be observed from different angles, as indicated for a point 26 by two dashed lines 28, 30 by way of example in the drawing. The evaluation device 24 in the illustrated exemplary embodiment is designed and configured for evaluating the output signals of the line sensor according to the stereo triangulation method. The operating principle of the stereo triangulation method is generally known, and therefore is not explained in greater detail here.

The sensor/illumination unit in principle may be designed in particular as known from flatbed scanners. In contrast to flatbed scanners, however, the evaluation device 24 is designed and programmed for evaluating output signals of the line sensor according to the stereo triangulation method, so that, based on the output signals of the line sensor, on the one hand an image of the scanned surfaces of the powder bed 6 is obtained, as known from flatbed scanners. On the other hand, in the evaluation device 24, surface depth information concerning the surface of the powder bed 6 is obtained based on the output signals of the line sensor, according to the stereo triangulation method, so that the three-dimensional topography of the surface of the powder bed 6 is reconstructed in this way.

The operating principle of the device 2 according to the invention is as follows:

Within the scope of a method for powder bed-based generative production of metallic components, prior to a melting operation the surface of the powder bed 6 is smoothed by means of an apparatus 17. After the smoothing, the surface of the powder bed 6 is scanned by means of the sensor/illumination unit by moving the sensor support 20 along the linear axis 22, with transmission of the output signals of the line sensor to the evaluation device 24. The output signals of the line sensor are evaluated in the evaluation device 24 according to the stereo triangulation method, the three-dimensional topography of the surface of the powder bed 6 being reconstructed based on the output signals of the line sensor.

Based on the reconstruction, it may then be determined whether the surface of the powder bed is sufficiently smoothed for the subsequent melting operation. If sufficient smoothing is determined, the control unit 12 may control the laser 8 for carrying out the next melting operation. In the event of insufficient smoothing, the control unit 12 may control the surface machining means (apparatus 17) for resmoothing the surface of the powder bed 6, and after the resmoothing, the surface of the powder bed 6 is rescanned by means of the line sensor. For the case that sufficient smoothing is subsequently present, the melting operation may be carried out. Otherwise, control of the laser 8 may be discontinued and an error message may be output.

In addition, if desired or necessary, the output signals that are output by the line sensor during the scanning may be combined to form an optical image of the surface of the powder bed 6.

According to the invention, it is also possible to store the topographies of the surface of the powder bed 6, determined in the evaluation device, so that during an inspection of the manufactured workpiece at a later point in time, criteria are present concerning which layer of the workpiece may possibly have a workpiece defect.

To allow measurement not only of the surface of the powder bed 6, but also of the component during its production, the evaluation device 24 is designed and configured for checking and/or measuring a cross-sectional area, formed by melting of the powder, of the component to be produced, based on the output signals of the optical sensor.

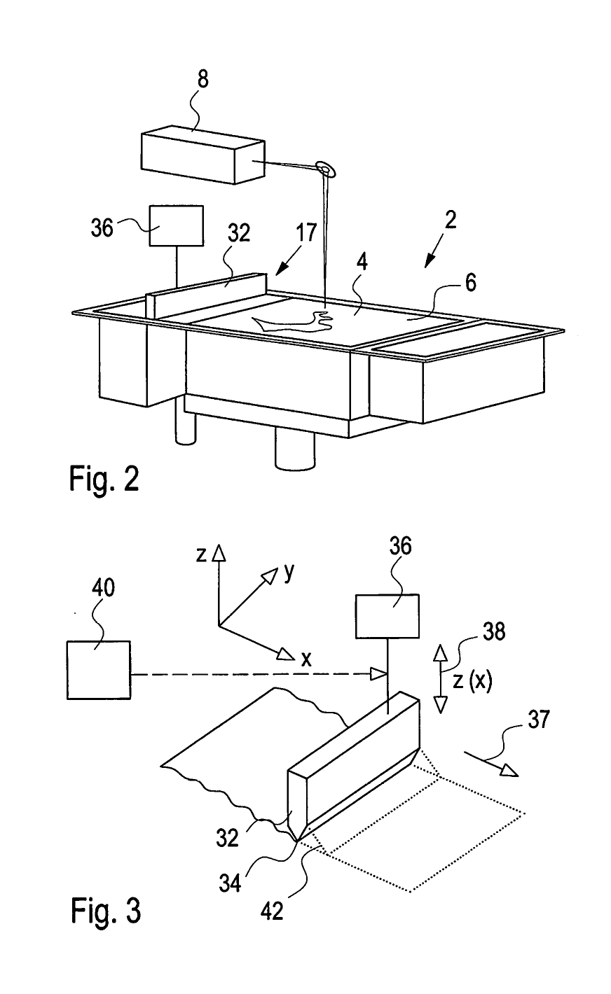

FIG. 2 shows another schematic perspective view of the device 2. In this exemplary embodiment, the surface machining means for machining the surface of the powder bed 6 have a pull-off element 32 which is designed in the manner of a doctor knife and which defines a pull-off edge (see FIG. 3). The pull-off element 32 is situated on a movable carrier 36, which is merely schematically indicated in the drawing. The carrier 36 is designed in such a way that the pull-off edge 34 is movable relative to the surface of the powder bed 6 in a pull-off plane (x-y plane in FIG. 3) in order to pull off the surface of the powder bed 6. In the illustrated exemplary embodiment, the carrier 36 is designed and configured for translational movement along a linear pull-off axis, the linear pull-off axis corresponding to the x axis in FIG. 3. The resulting pull-off direction is denoted by an arrow 37 in FIG. 3.

Other kinematics of the movement of the carrier 26 for pulling off the surface of the powder bed 6 by means of the pull-off element 32, for example a windshield wiper-like movement, are likewise possible according to the invention.

The pull-off plane corresponds to the x-y plane in FIG. 3. According to the invention, the pull-off element 32 is situated on the carrier 36 so as to be adjustable, relative to the carrier, along an adjustment axis perpendicular to the pull-off plane in order to set a pull-off position of the pull-off edge 34. In FIG. 3 the adjustment axis corresponds to the z axis, as indicated by a double arrow 38 in FIG. 3. A drive device 40, illustrated purely schematically in FIG. 3, is associated with the adjustment axis.

According to the invention, the position of the pull-off element 32, and thus of the pull-off edge 34, along the adjustment axis (z axis) is thus adjustable by means of the drive device 40. It is apparent that the particular layer thickness of a powder layer to be applied may be set by an appropriate setting of the pull-off element 32 relative to the surface of the powder bed 6. In this way, according to the invention the surface of the powder bed 6 may be shaped according to a desired topography.

During operation of the device 2, after a melting operation is carried out to form a layer of the workpiece to be generated, a new powder layer is applied. In order for a subsequent melting operation to be carried out once again in the same plane as in the preceding melting operation, a carrier (base plate) on which the material reservoir together with the powder bed 6 and the workpiece to be generated are situated is lowered, in particular by a height that corresponds to the thickness of the layer of the component generated in the preceding melting operation.

Additional powdered metal material, also referred to below as powder for short, is subsequently introduced into the material reservoir. In the illustrated exemplary embodiment, the x axis corresponds to the linear axis (pull-off axis) along which the pull-off element 32 moves during a pull-off operation. If the pull-off element 32 is in the position illustrated in FIG. 2, for example, the powder is introduced into the material reservoir in front of the pull-off element 32 in the pull-off direction, so that during the pull-off operation, i.e., for a movement of the pull-off element 32 along the x axis in FIG. 2 or FIG. 3 from left to right, the introduced powder moves in front of the pull-off element 32 in the shape of a “bow wave,” as indicated by reference numeral 40 in FIG. 3. By setting an appropriate pull-off position of the pull-off edge 34 along the adjustment axis (z axis), the particular layer thickness of a powder layer that is applied during this pull-off operation may be set.

The pull-off position may be fixed relative to the carrier 36 during the pull-off operation, so that a powder layer of uniform layer thickness (corresponding to the pull-off position of the pull-off edge) is applied during a movement of the pull-off edge 34 over the entire surface of the powder bed 6.

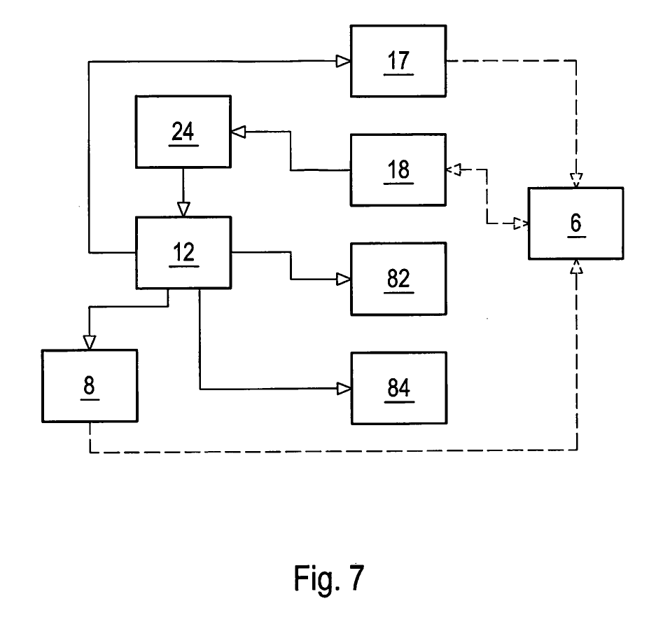

However, it is also possible to change the pull-off position during the pull-off operation, so that the layer thickness of the powder layer during the pull-off operation varies along the pull-off axis (x axis) i.e., along the surface of the powder bed 6. The pull-off position is set via control by the control unit 12 by appropriate actuation of the drive device 40 (see FIGS. 3 and 7).

However, to improve the pourability of the powder it is also possible during the pull-off operation to move the pull-off edge 34 about a zero position corresponding to a high-frequency oscillation. The zero position then defines the pull-off position, in other words, the width of the gap between the pull-off edge 34 and the surface of the powder bed 6.

The embodiment illustrated in FIG. 3 thus allows the topography of the surface of the powder bed 6 to be influenced by structuring machining of the surface of the powder bed 6.

After carrying out a pull-off operation, a check may be made, using the measuring device 18, as to whether the surface of the powder bed has the desired topography. If the pull-off operation has resulted in the desired topography, for example a flat powder layer along the entire surface of the powder bed 6, after the measurement the control unit 12 may actuate the laser 8 to carry out the next melting operation.

The corresponding operations proceed fully automatically until the component is generated in the desired manner.

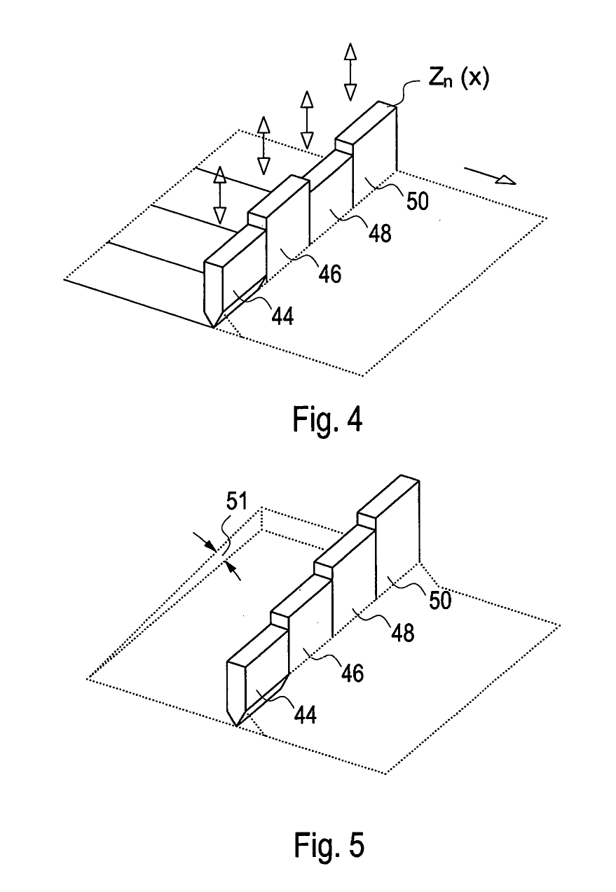

FIG. 4 shows another exemplary embodiment that differs from the exemplary embodiment according to FIG. 3, in that the pull-off edge 34 is formed by at least two pull-off elements next to and adjoining one another in the longitudinal direction of the pull-off edge 34. In the illustrated exemplary embodiment, for explaining the functional principle four pull-off elements 44, 46, 48, 50 are symbolically depicted strictly by way of example. It is apparent that, depending on the particular requirements, a plurality of pull-off elements next to and adjoining one another in the longitudinal direction of the pull-off edge 34 is possible, and is desirable with respect to the finest possible spatially resolved structurability of the topography of the surface of the powder bed 6.

A separate, independently controllable drive device is associated with each of the pull-off elements 44 through 50, the drive devices being controlled by the control unit (see FIG. 7). In the illustrated exemplary embodiment, each of the drive devices is formed by a piezo actuator.

Whereas in the exemplary embodiment according to FIG. 3, spatially resolved structuring of the surface of the powder bed 6 along the pull-off axis (z axis) is possible, the exemplary embodiment according to FIG. 4 also allows spatially resolved structuring of the surface of the powder bed 6 in the longitudinal direction of the pull-off edge 34 and thus, transverse to the pull-off axis, i.e., along the y axis. The spatial resolution of the structuring is higher the more pull-off elements that are provided. Thus, in principle a high resolution is achievable via an appropriate number of pull-off elements 44 through 50.

Thus, within the scope of the given spatial resolution, any desired topography of the surface of the powder bed 6 is settable by appropriate control of the drive devices associated with the pull-off elements 44-50.

If the pull-off edge 34 is inclined relative to a base plate on which the powder bed 6 rests, a different vertical setting of the pull-off elements 44-50 along the y axis may be utilized to compensate for the inclined position of the pull-off edge 34 with respect to the base plate, as indicated by reference numeral 51 in FIG. 5.

For structuring the surface of the powder bed 6 according to a desired topography, initially the topography of the powder surface is measured in three dimensions by means of the measuring device 18. The measuring device 18 is in signal transmission connection with the control unit 12 for controlling the drive devices, in such a way that the drive devices are controlled as a function of the measuring result of the measuring device 18. The control unit 12 is programmed for automatically controlling the drive devices as a function of the measuring result of the measuring device, so that during the pull-off operation a desired topography of the surface of the powder bed 6 is automatically formed.

If a uniform layer thickness in the x direction is desired over the entire extension of the surface of the powder bed 6, the position of the pull-off elements 44-50 (pull-off position) set by the control unit 12 is maintained during the pull-off operation.

In contrast, if a topography that varies in the x direction is desired or necessary, the control unit 12 appropriately controls the drive devices of the pull-off elements 44 through 50 during the pull-off operation.

In this way, in terms of the possible spatial resolution and the properties of the powder, virtually any desired structuring of the surface of the powder bed 6 is made possible, depending on the particular requirements, thus increasing the freedom of design for the process parameters of the powder bed-based generative production method. In particular, an automatic setting of the pull-off edge 34 with respect to the base plate on which the powder bed 6 rests, with regard to the angular orientation of the base plate is made possible.

In particular, an initial installation as well as a reinstallation of the pull-off edge 34 after damage are automatically possible. In addition, the powder consumption may be minimized due to the design according to the invention.

This results in overall higher productivity of the device 2.

The pull-off elements 44-50 may be situated on a pull-off element module, the pull-off element module or a portion of the pull-off element module being detachably connected or connectable to the carrier 36.

The pull-off element module may preferably have a passive pull-off edge module, on which a plurality of adjacently situated pull-off edge elements, independently movable in the direction along the adjustment axis, are situated, and an active actuator module on which a plurality of independently controllable actuators as drive devices are situated, each of which is associated with one of the pull-off edge elements in order to adjust same along the adjustment axis.

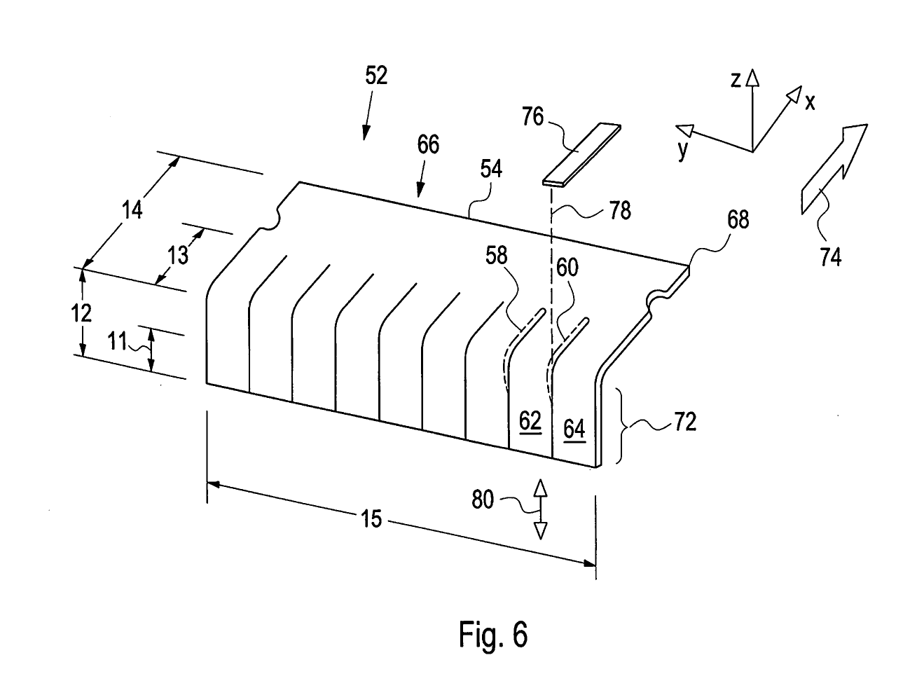

FIG. 6 illustrates an example of one design of such a pull-off edge module 52, having a strip 54 made of sheet metal with an angular shape, and having a first leg 56 that is divided into tongue-like pull-off edge segments by indentations spaced apart from one another along the longitudinal direction of the pull-off edge 34. In FIG. 6, two indentations are denoted by reference numerals 58, 60, and two pull-off edge segments are denoted by reference numerals 62, 64 by way of example.

The second leg 66 of the strip 54 is situated on the carrier 36. The movability of the sheet metal edges, which function as pull-off edge segments 62, 64, is achieved by elastic bending of the leg 66 that is fixed at the position denoted by reference numeral bd.

The sheet thickness of the strip 54 and the width of the indentations 58, 60, which may be produced by cutting with an ultrashort pulse laser or by etching, are coordinated in such a way that the individual pull-off edge segments 62, 64 in their bottom area move essentially in parallel to one another in the z direction, at least for the relatively small deflections compared to the cantilever length. This ensures that preferably little powder of the “bow wave” is able to pass through the spaces between the pull-off edge segments 62, 64.

It is desirable for the powder to travel past the pull-off edge module 52, to the greatest extent possible, solely beneath the portions of the pull-off edge segments 62 that define the pull-off edge 34. If necessary, depending on the particular requirements, elastic sealing material may be used, as indicated by reference numeral 72. The height extension and the viscosity of the sealing material are set in such a way that on the one hand a relatively free movement of the individual pull-off edge segments 62, 64 in the z direction remains possible. On the other hand, the sealing material 72 should prevent passage of powder between the pull-off edge segments 62, 64 to the greatest extent possible. As an ancillary effect, the elastic sealing material 72 may also become apparent as a vibration damper, which benefits rapid height adjustability of the pull-off edge segments 62, 64.

The pull-off direction is denoted by an arrow 74 in FIG. 6.

To allow the pull-off edge segments 62, 64 and the further pull-off edge segments to be actuated independently of one another, an independently actuatable drive device, which in the illustrated exemplary embodiment is formed by a piezo actuator, is associated with each pull-off edge segment. A piezo actuator that is associated with the pull-off edge segment 62 is indicated in a purely schematic fashion and provided with reference numeral 76 in FIG. 6. An impingement axis of the actuator 76 is denoted by a dashed line 78 in FIG. 5. For reasons of illustration, the piezo actuator 76 and the associated pull-off edge segment 62 are illustrated relatively far apart from one another in FIG. 5. In practice, in the sense of a short actuating travel the piezo actuator rests against the pull-off edge segment 62, so that the latter is deflected along the adjustment axis when the piezo actuator is actuated, as indicated by a double arrow 80 in FIG. 6.

Typical dimensions for implementing the pull-off edge module 52 are given in millimeters in FIG. 6.

Piezo elements having a stacked or bimorph design may be used as piezo actuators. These actuators have advantages for the intended use, since on the one hand they may be quickly modulated and require very little additional energy for holding a given position. Such actuator modules are also known from other products and are well-established. Actuator strips having more than 80 closely spaced actuators are commercially available.

In the installed position on the pull-off edge module 52, the actuator module is preferably clamped to the passive pull-off edge module 52 with a certain mechanical pretension along the adjustment axis (z axis). The pretension of the individual actuators shifts the working area of the piezos from a symmetrical position in the tension-compression range toward a position situated closer to the compression range.

A different base deflection of the pull-off edge segments 62, 64 generally occurs due to component tolerances in the passive or active module. In conjunction with a measuring 3D topography system (measuring device 18), a first test pull-off may be carried out in the powder bed. The different heights of the powder bed strips that result are measured by means of the measuring device 18, and are compensated for as an offset during subsequent regular operation. By repeating the operation for one or more different deflections of the piezos, for each pull-off edge segment 62, 64 the sensitivity factor (expressed as deflection as a function of applied voltage) may, if necessary, also be determined as nonlinearity and subsequently compensated for.

One refinement of the device 2 that has independent inventive importance in combination with the pull-off element that is movable along an adjustment axis by means of a drive device, but also independently thereof, provides an apparatus 82 (see FIG. 6) for removing material from the powder bed 6 and/or for displacing material within the powder bed 6. The apparatus 82 is controlled by the control unit 12, and in this exemplary embodiment is designed as a suction unit that acts in the manner of a vacuum cleaner. The apparatus 82 is used to selectively remove material from the powder bed. If it is determined during the optical measurement of the powder bed by means of the optical measuring device 18 that melt residues, for example, that have formed during a preceding melting operation are present in the powder bed, these melt residues may be removed from the powder bed in a targeted manner by means of the apparatus 82. In this way, the melt residues are prevented from impairing the further generative production method, which in particular results in defects in the component to be produced.

The apparatus 82 together with the pull-off element 32 may be situated on the movable carrier 36.

To be able to reach every location on the surface of the powder bed 6 during the pull-off operation, it is advantageous for the apparatus 82 to be movable (preferably together with the pull-off element 82) not only in the pull-off direction (x direction), but also transversely with respect to the pull-off direction, i.e., in the y direction.

With regard to a simple design, it is advantageous when the apparatus 82 together with the pull-off element 32 is situated on the movable carrier 36. However, it is also possible for the apparatus 82 to be situated on a separate carrier, by means of which the apparatus 82 is movable along the surface of the powder bed 6, i.e., at least in the x direction, but advantageously in the x and y directions.

According to the invention, the apparatus 82 may also be used to selectively remove powder from the powder bed.

Another refinement of the device 2 that has independent inventive importance in combination with the above-mentioned embodiments, but also independently of same, provides an apparatus 84, which is controllable by the control unit 12, for selectively introducing powder material into the powder bed.

As described above, the application of a new powder layer takes place in such a way that the powder is introduced in front of the pull-off edge 34 in the pull-off direction, and during the pull-off operation is distributed in the form of a uniform layer on the surface of the powder bed. By means of the apparatus 84, which is preferably movable along the surface of the powder bed in two dimensions, i.e., in the x and y directions, powder may be selectively introduced, independently thereof, at surface locations on the powder bed 6, if this is necessary. The apparatus 84 may be designed in the manner of an outlet nozzle 84, for example. The apparatus 84 may be situated on the carrier 36 of the pull-off element 32, so that the apparatus 84 is moved together with the pull-off element. However, to decouple the pull-off operation (pull-off element 32) from the operation of selective introduction of powder (apparatus 84), it is advantageous for the apparatus 84 to be situated on a separate carrier that is movable along the surface of the powder bed.

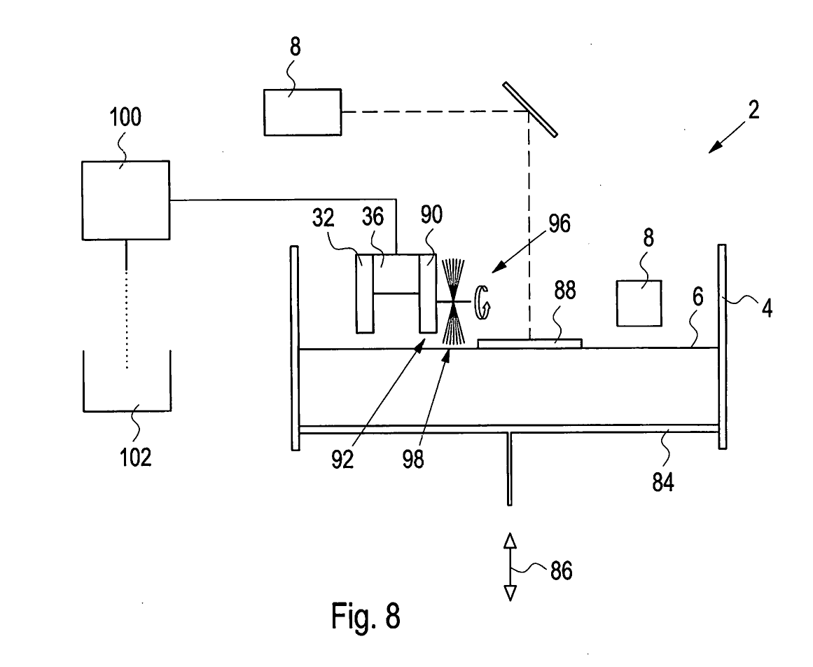

To further improve the functional reliability and cost efficiency of the device 2, in the illustrated exemplary embodiment the surface machining means have means 82 for removing material from the powder bed 6 and/or from the component. These means are explained in greater detail, based on one exemplary embodiment and with reference to FIGS. 8 through 10.

FIG. 8 shows a highly schematic diagram. The material reservoir 4, which accommodates the powder bed 6, is situated on a powder bed carrier 84 that is movable perpendicularly to the surface of the powder bed 6 in the direction of a double arrow 86.

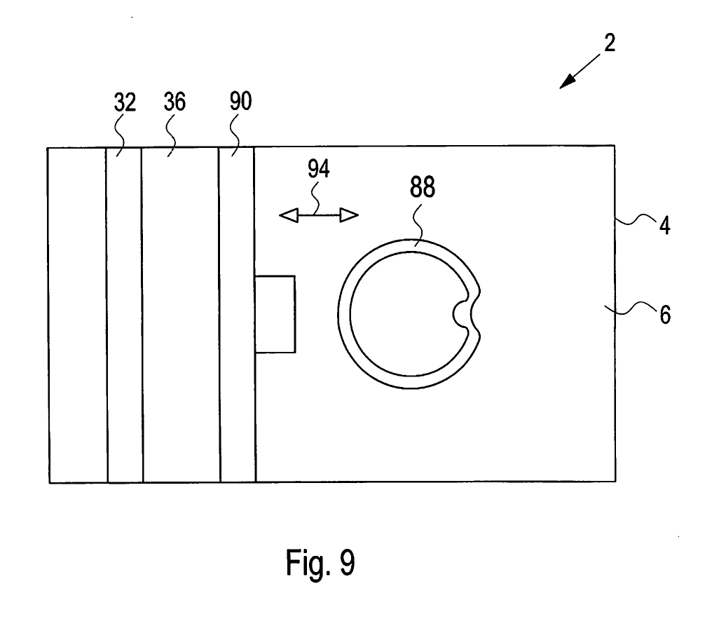

After a melting operation is carried out, the powder bed carrier 68 is lowered, in a known manner, by an amount that corresponds to the thickness of the layer of the component, formed in the melting operation, perpendicular to the surface of the powder bed 6. During the layered building of the component, the melting operation thus always takes place in the same plane. The component is schematically indicated and denoted by reference numeral 88 in FIGS. 8 and 9.

In the illustrated exemplary embodiment, the means 82 for removing material from the powder bed 6 and/or from the component 88 are designed and configured for removing powder from the powder bed 6.

The means 82 have an apparatus that is designed as a suction unit 90 having at least one suction nozzle 92. In the illustrated exemplary embodiment, the suction nozzle 92 extends over the entire width of the powder bed (see FIG. 9).

The suction unit 90 is situated on the carrier 36, on which the pull-off element 32, illustrated in FIGS. 8 and 9 as a single pull-off element and merely schematically indicated, is also situated.

The carrier 36 is movable along the surface of the powder bed 6 along a double arrow 94 to allow powder to be suctioned off at any desired location on the powder bed 6.

In the illustrated exemplary embodiment, the means 82 for removing material from the powder bed 6 and/or from the component 88 also have an apparatus 96 with a brush-like design, which in the illustrated exemplary embodiment has a single rotating brush 98 that is associated with a rotary drive, not illustrated in greater detail.

The operating principle of the device 2 with the means 82 for removing material from the powder bed 6 and/or from the component 88 is as follows:

After a melting operation is carried out, the three-dimensional topography of the surface of the powder bed 6 and of the component 88 is measured by means of the optical measuring device 18, and the associated measured data are transmitted to the evaluation device 24. In the evaluation device it is then determined, based on the measured data, whether the production method is taking place in the desired manner, or whether corrective interventions in the process sequence are necessary. In particular, based on the measured data it may be determined whether and to what extent melt particles (metal spatters) that have formed during the melting operation are present in the powder bed 6 or have accumulated on the component 88.

If it is determined in the evaluation device 24 that no melt particles or other anomalies that could interfere with the subsequent melting operation are present in the powder bed 6 or on the component 88, according to the general process sequence the powder bed carrier 68 may be lowered and a new powder layer may be applied to the surface of the powder bed b.

The application of a new powder layer may take place as described with reference to FIGS. 2 through 7.

If it is determined by evaluation of the measured data that melt particles or other anomalies that could interfere with the subsequent melting operation are present in the powder bed 6 or on the component 88, these melt particles or anomalies may be removed from the powder bed 6 or from the component 88 by use of the means 82.

The evaluation of the measured data of the measuring device 18 readily allows localization of individual anomalies, so that the anomalies may be subsequently removed in a targeted manner.

In contrast, in the illustrated exemplary embodiment the removal of anomalies takes place by suctioning off the uppermost layer or the uppermost layers of the powder bed 6.

For this purpose, the carrier 36 together with the suction unit 90 in FIG. 9 moves from left to right, for example, over the entire extension of the powder bed 6. During this movement, the surface layer of the powder bed 6 is suctioned off by means of the suction unit in the manner of a vacuum cleaner.

The suctioned powder in addition to metal spatters, foreign bodies, or other anomalies may be disposed of. However, the suctioned material is advantageously filtered in a filter unit 100 in order to separate melt particles or other foreign bodies, for example, from the actual powder.

The powder that is purified in this way may then be supplied to a powder reservoir 102 and reused within the scope of the further production method. If powders of different types are present in the powder bed 6, they may likewise be separated from one another in the filter unit 100.

Melt particles or other melt bodies adhering to the component 88 may be removed from the component 88 by means of the brush 98 during the movement of the carrier 36 along the surface of the powder bed. The removed melt particles or other foreign bodies are suctioned off by means of the suction unit 90.

After the surface layer of the powder bed 6 has been suctioned, and melt particles, other foreign bodies, or other anomalies that could interfere with the subsequent melting operation have thus been removed from the powder bed 6, a new powder layer may be applied. The application of the powder layer may take place as described above with references to FIGS. 2 through 7.

The suctioning of the surface layer and the application of a new surface layer may take place in two passes during the movement of the carrier 36 along the surface of the powder bed, in that initially the surface layer is suctioned during a forward movement in one direction of the double arrow 94, and a new surface layer is applied during a backward movement of the carrier 36 in the opposite direction of the double arrow 94.

However, it is also possible to carry out the suctioning of the surface layer and the application of a new surface layer in a single pass, i.e., during a single movement of the carrier 36 along the surface of the powder bed 6. For example, during a movement 6 of the carrier 36 to the right in FIG. 8 by means of the apparatuses 90, 96, material may be removed from the powder bed 6 or from the component 88. Via a delivery downstream from the apparatus 90, powder may be introduced into the space between the apparatus 90 and the pull-off element 32, and the introduced powder may be shaped, in particular smoothed, by means of the pull-off element 32, during the movement of the carrier 36. After the removal and reapplication of the surface layer in a single pass of the movement of the carrier 36, the carrier may be moved back into the starting position at increased speed.

The layer thickness of the suctioned surface layer is selectable within wide limits, depending on the particular requirements. The same applies for the layer thickness of the new surface layer to be applied.

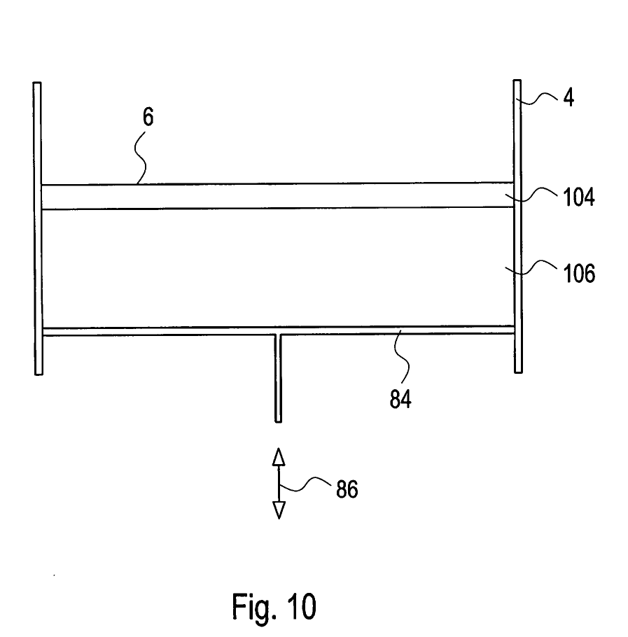

One exemplary embodiment of a production method according to the invention for powder bed-based generative production of metallic components is explained in greater detail below with reference to FIG. 10, wherein meltable metal material is kept in the material reservoir in the above-described manner, wherein the metal material in the metal reservoir 4 forms a powder bed. An appropriate cross section 1 of the component to be generated is selectively melted into the powdered metal material by means of the melting device 8.

According to the invention, means for removing material from the powder bed 6 and/or from the component 88 are provided, via which material is removed from the powder bed 6 and/or from the component 88 during the sequence of the production method in preparation for a melting operation. The removal of material may take place as described in greater detail above with reference to FIGS. 8 and 9.

The process reliability and cost efficiency in the powder bed-based generative production of metallic components are significantly increased by use of the device 2 according to the invention and the method according to the invention. In addition, the quality of the components generated by means of the method according to the invention and the device according to the invention is significantly improved.

Whereas in the exemplary embodiments according to FIGS. 1 through 9 the powder bed is formed by a single type of powder, in the exemplary embodiment according to FIG. 10 the powder bed 6 is formed from the layering of a component powder layer 102, which forms the surface of the powder bed 6 and is made of meltable component powder for generating the component 88, and a filling powder layer 106 situated beneath the component powder layer 104. The component powder layer 104 is used to generate the component 88, while the filling powder layer 106 is used to dissipate heat that results during the melting of the component powder 104. Accordingly, the powder of the filling powder layer 106 is selected for optimizing the dissipation of heat that results during the melting of the component powder, and has a higher thermal conductivity than the component powder. For example, the component powder may be made of titanium and the filling powder may be made of copper.

A relatively thin component powder layer 104 is advantageously situated on a relatively thick filling powder layer 106 in terms of effective heat dissipation. The heat dissipation during the production method is thus significantly improved, and the process reliability of the production method as well as the quality of the produced components are significantly improved.

To maintain the advantage of improved heat dissipation during the entire production process, the component powder layer is removed after a melting operation. The removal of the component powder layer may take place as described above with reference to FIGS. 8 and 9.

After the component powder layer 104 is removed, additional filling powder is applied to build up the filling powder layer 106. The application of the filling powder layer 106 may in principle take place as described above with reference to FIGS. 1 through 7, provided that no particularly stringent requirements are to be imposed on the shaping of the surface of the filling powder layer 106, since the filling powder layer 106 does not take part in the actual melting operation, and instead is covered by the component powder layer 104 during the operating state of the device 2.

After the additional filling powder is applied, a new component powder layer 104 is subsequently applied thereto, wherein the application of the new component powder layer 104 may likewise take place as described above with reference to FIGS. 2 through 7.

This operation is repeated until the production method concludes and the component 88 is produced.

All of the above-described operations may proceed fully automatically under control by the control unit 12, so that monitoring of the device 2 is largely unnecessary. The productivity during the production of components is increased significantly in this way.

As a result, the invention in many respects provides improvements of the known devices and production methods.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. A device for powder bed-based generative production of metallic components, comprising:
a material reservoir for accommodating a powdered metal material that is meltable by means of a melting device, the material in the material reservoir forming a powder bed;
a surface machining means for machining the surface of the powder bed;
means for determining the three-dimensional topography of the surface of the powder bed that are designed and configured in such a way that the three-dimensional topography of the surface is determined or determinable by obtaining surface depth information concerning the surface; and
the means for determining the three-dimensional topography of the surface of the powder bed is in signal transmission connection with the surface machining means in such a way that the surface of the powder bed is machined or machinable as a function of output signals of the means for determining the three-dimensional topography of the surface of the powder bed that represent the three-dimensional topography of the surface of the powder bed, before carrying out a melting operation by the surface machining means.

2. The device according to claim 1, wherein:
the means for determining the topography of the surface of the powder bed are fixedly installed in the device, and are integrated into a control unit of the device for control purposes.

3. The device according to claim 1, wherein:
the means for determining the topography of the surface of the powder bed have optical means that are designed and configured in such a way that the topography of the surface of the powder bed is determined or determinable by obtaining surface depth information.

4. The device according to claim 1, wherein:
the melting device has at least one laser and/or at least one electron beam melting device whose laser beam or electron beam, respectively, under control by a control unit, is movable along the surface of the powder bed and variable in its intensity for selectively melting the powdered metal material.

5. The device according to claim 1, wherein:
the surface machining means has at least one smoothing device for smoothing the surface of the powder bed.

6. The device according to claim 1, wherein:
the means for determining the topography of the surface are designed and configured for measuring the surface of the powder bed and have at least one measuring device capable of 3D measurement.

7. The device according to claim 6, wherein:
the measuring device is designed as an optical measuring device or includes an optical measuring device.

8. The device according to claim 7, wherein:
the optical measuring device has at least one optical sensor that is in data transmission connection with an evaluation device that is designed and configured in such a way that the topography of the surface of the powder bed is reconstructed or reconstructable from the output signals of the sensor, using a 3D reconstruction method.

9. The device according to claim 8, wherein:
the optical sensor is designed for scanning the surface of the powder bed.

10. The device according to claim 9, wherein:
the optical sensor is situated on a carrier that is movable relative to the surface of the powder bed.

11. The device according to claim 10, wherein:
the optical sensor is designed as a line sensor and has a linear arrangement of sensor elements.

12. The device according to claim 10, wherein:
the carrier is linearly movable relative to the material reservoir.

13. The device according claim 10, wherein:
the carrier is rotatable relative to the material reservoir, in particular in the manner of a windshield wiper.

14. The device according to claim 3, wherein:
an illumination device is provided for illuminating the surface of the powder bed, at least in an area detected by the sensor.

15. The device according to claim 14, wherein:
the illumination device is designed and configured for illuminating the surface of the powder bed at different illumination angles, and that the evaluation device is designed and configured for evaluating output signals of the optical sensor, obtained during illumination at different illumination angles, according to the shape from shading method.

16. The device according to claim 8, wherein:
the optical sensor is designed and configured for observing a measuring point on the surface of the powder bed from different observation angles.

17. The device according to claim 16, wherein:
the evaluation device is designed and configured for evaluating output signals of the optical sensor according to the stereo triangulation method.

18. The device according to claim 8, wherein:
the at least one optical sensor is designed as a distance sensor that measures single points, and the topography of the surface of the powder bed is determined by ascertaining the distance between the sensor and the surface at the particular measuring point detected by the sensor.

19. The device according to claim 14, wherein:
the sensor is integrated with the illumination device to form a sensor/illumination unit.

20. The device according to claim 19, wherein:
the sensor/illumination unit is situated on the carrier.

21. The device according to claim 8, wherein:
the evaluation device is designed and configured for checking and/or measuring a cross-sectional area, formed by melting on of the powder, of the component to be produced, based on the output signals of the optical sensor.

22. The device according to claim 1, wherein:
the surface machining means have at least one pull-off element for shaping the surface of the powder bed, wherein the pull-off element is designed in the manner of a doctor knife and defines a pull-off edge, wherein the, or each, pull-off element is situated on a movable carrier, and wherein the carrier is designed in such a way that the pull-off edge for pulling off the surface of the powder bed relative to the powder bed is movable in a pull-off plane, wherein the, or each, pull-off element is situated on the carrier so as to be adjustable, relative to the carrier, along an adjustment axis perpendicular to the pull-off plane in order to set a pull-off position of the pull-off edge, wherein during the pull-off operation the pull-off position, at least in phases, is fixed or is changeable relative to the carrier, corresponding to a high-frequency oscillation about a zero position, and wherein a drive device is associated with the adjustment axis.

23. The device according to claim 22, wherein:
the pull-off edge is formed by at least two pull-off elements next to and adjoining one another in the longitudinal direction of the pull-off edge.

24. The device according to claim 23, wherein:
the pull-off edge is formed by a plurality of pull-off elements next to and adjoining one another in the longitudinal direction of the pull-off edge.

25. The device according to claim 23, wherein:
a separate, independently controllable drive device is associated with at least two pull-off elements, preferably each of the pull-off elements.

26. The device according to claim 25, wherein:
at least one drive device is designed as a piezo actuator.

27. The device according to claim 22, wherein:
a control unit is provided for controlling the drive device or the drive devices.

28. The device according to claim 27, wherein:
a measuring device is provided for three-dimensional measurement of the topography of the surface of the powder bed.

29. The device according to claim 8, wherein:
the measuring device is in signal transmission connection with the control unit for controlling the drive device or the drive devices, in such a way that the drive device or the drive devices is/are controlled or controllable as a function of the measuring result of the measuring device.

30. The device according to claim 29, wherein:
the control unit is programmed for automatically controlling the drive device or the drive devices as a function of the measuring result of the measuring device, in such a way that a desired topography of the surface of the powder bed is automatically formed.

31. The device according to claim 29, wherein:
the measuring device is designed as an optical measuring device.

32. The device according to claim 22, wherein:
the pull-off element or the pull-off elements is/are situated on a pull-off element module.

33. The device according to claim 32, wherein:
the pull-off element module or a portion of the pull-off element module is detachably connected or connectable to the carrier.

34. The device according to claim 32, wherein:
the pull-off element module has a passive pull-off edge module on which a plurality of adjacently situated pull-off edge elements, independently movable in the direction along the adjustment axis, are situated, and an active actuator module on which a plurality of independently controllable actuators are situated, each of which is associated with one of the pull-off edge elements in order to adjust same along the adjustment axis.

35. The device according to claim 34, wherein:
the actuator module is fixedly connected to the carrier, and the pull-off edge module is detachably connected to the carrier.

36. The device according to claim 34, wherein:
the pull-off edge module has a strip, made of sheet metal or some other elastically resilient material with an angular shape, that has a first leg that is divided into tongue-like pull-off edge segments by indentations spaced apart from one another along the longitudinal direction of the pull-off edge, and that has another leg that is connected or connectable to the carrier or to a component joined to the carrier, wherein each of the pull-off edge segments is movable along the adjustment axis by an associated actuator.

37. The device according to claim 22, wherein:
a vibration device is provided for acting on the pull-off element or the pull-off elements with high-frequency oscillations.

38. The device according to claim 22, wherein:
the carrier is designed and configured for a translational movement along a linear pull-off axis.

39. The device according to claim 22, wherein:
at least one pull-off element is translationally movable for adjustment along the adjustment axis.

40. The device according to claim 22, wherein:
at least one pull-off element is rotatable about a rotational axis for adjustment along the adjustment axis.

41. The device according to claim 1, wherein:
means is provided for removing material from the powder bed and/or from the component.

42. The device according to claim 41, wherein:
the means for removing material from the powder bed and/or from the component is designed and configured for displacing material along the surface of the powder bed.

43. The device according to claim 41, wherein:
the means for removing material from the powder bed and/or from the workpiece is designed and configured for removing melt particles or other foreign bodies from the powder bed and/or from the component.

44. The device according to claim 41, wherein:
the means for removing material from the powder bed and/or from the workpiece is designed and configured for removing powder from the powder bed.

45. The device according to claim 41, wherein:
means for detecting and/or localizing melt particles or other foreign bodies in the powder bed and/or on the workpiece is provided.

46. The device according to claim 41, wherein:
a measuring device is provided for measuring the surface of the powder bed and/or of the component.

47. The device according to claim 46, wherein:
the measuring device is an optical measuring device.

48. The device according to claim 46, wherein:
the measuring device is in data transmission connection with an evaluation device that is designed and programmed for detecting and/or localizing melt particles and other foreign bodies in the powder bed and/or on the component, in such a way that the evaluation device, based on the measured data, detects melt particles or other foreign bodies and thus constitutes the means for detecting and/or localizing melt particles or other foreign bodies in the powder bed and/or on the workpiece.

49. The device according to claim 48, wherein:
the evaluation device is in data transmission connection with a control unit and transmits evaluation data to the control unit that represent the presence and/or the position of melt particles or other foreign bodies detected in the powder bed and/or on the component, wherein the control unit is designed and programmed for controlling the means for removing material from the powder bed and/or from the component, in such a way that the means for removing material from the powder bed and/or from the component remove detected melt particles or other foreign bodies from the powder bed or from the component.

50. The device according to claim 41, wherein:
the means for removing material from the powder bed and/or from the component have at least one apparatus, situated on a carrier, for removing material from the powder bed and/or from the component, the carrier being movable relative to the surface of the powder bed.

51. The device according to claim 10, wherein:
the means for removing material from the powder bed and/or from the component has at least one apparatus that is designed as a suction unit having at least one suction nozzle.

52. The device according to claim 50, wherein:
the means for removing material from the powder bed and/or from the component has at least one brush-like apparatus.

53. The device according to claim 52, wherein:
the brush-like apparatus has at least one rotating brush.

54. The device according to claim 51, wherein:
at least one suction nozzle is designed for pinpoint suction.

55. The device according to claim 51, wherein:
at least one suction nozzle is designed for linear or flat suction.

56. The device according to claim 51, wherein:
at least one suction unit is designed for suctioning out powder from the powder bed.

57. The device according to claim 51, wherein:
a filter unit for filtering suctioned material is situated downstream from at least one suction unit.

58. The device according to claim 51, wherein:
at least one apparatus for removing material from the powder bed and/or from the component together with an apparatus for introducing powder into the powder bed are situated on a shared carrier that is movable along the surface of the powder bed.

59. The device according to claim 41, wherein:
a control unit is provided for automatically controlling the means for removing material from the powder bed and/or from the component.
